(19) United States
(12) Patent Application Publication
(10) Pub. No.: US 2010/0309399 A1
(43) Pub. Date: Dec. 9, 2010

(54) LIQUID CRYSTAL DISPLAY APPARATUS AND DRIVING METHOD THEREOF

(75) Inventors: Sweehan J.H. Yang, Tainan City (TW); Po-Sheng Shih, Hsinchu City (TW); Ra-Bin Li, Tainan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Hannstar Display Corporation, Taipei City (TW)

(21) Appl. No.: 12/571,446

(22) Filed: Oct. 1, 2009

(30) Foreign Application Priority Data
Jun. 5, 2009 (TW) 98118790

(51) Int. Cl. G09G 3/36; G02F 1/1343

(52) U.S. Cl. 349/37; 349/38

(57) ABSTRACT

An LCD apparatus and a driving method thereof are provided. The LCD apparatus includes a reference voltage line and a display area including scan lines, data lines and pixel structures. Each pixel structure is electrically connected to the corresponding scan/data line, and has a first pixel area and a second pixel area. The first pixel area includes a first liquid crystal capacitor with one end electrically connected to a common voltage. The second pixel area includes a second liquid crystal capacitor and a first compensation capacitor. One end of the second liquid crystal capacitor is electrically connected to the common voltage, one end of the first compensation capacitor is electrically connected to the second liquid crystal capacitor and another end is electrically connected to a reference voltage source through the reference voltage line. The reference voltage source provides a reference voltage having a continuous periodic signal or a time-varying signal.

### CROSS-REFERENCE TO RELATED APPLICATION

This application claims the priority benefit of Taiwan application serial no. 98118790, filed on Jun. 5, 2009. The entirety of the above-mentioned patent application is hereby incorporated by reference herein and made a part of specification.

### BACKGROUND OF THE INVENTION

1. Field of the Invention

The present invention relates to a flat panel display technique; more particularly, to a driving method that can mitigate a horizontal crosstalk phenomenon of a liquid crystal display apparatus.

2. Description of Related Art

FIG. 1 is a partial equivalent circuit diagram of a conventional single cell gap transflective liquid crystal display (LCD) panel, wherein the so-called single cell gap refers that a distance between a pixel electrode in a transmissive area and a common electrode is approximate equal to a distance between a reflective electrode in a reflective area and the common electrode. Referring to FIG. 1, a pixel unit of the single cell gap transflective LCD panel 120 includes a scan line 122, a data line 124 and a pixel structure 126, wherein the pixel structure 126 has a transmissive area T1 and a reflective area R1, and includes an active device 126T, a storage capacitor Cₛₜ and a compensation capacitor C_{C} located in the transmissive area T1 and reflective area R1 respectively. A liquid crystal capacitor in the transmissive area T1 is a first liquid crystal capacitor C_{LCA}, and a liquid crystal capacitor in the reflective area R1 is a second liquid crystal capacitor C_{LCB}.

According to FIG. 1, it is known that the first liquid crystal capacitor C_{LCA} and the second liquid crystal capacitor C_{LCB} are all electrically connected to a common voltage VcomA. The pixel electrode of the transmissive area T1 and the reflective electrode of the reflective area R1 respectively have different pixel voltage values, so that a transmissive and a reflective display can be simultaneously implemented by the single cell gap transflective LCD panel 120.

FIG. 2 is a diagram illustrating characteristic curves of transmittance and pixel voltages of an image displayed in the transmissive area and the reflective area of FIG. 1. Referring to FIG. 2, a curve 112 is a characteristic curve of the transmittance and the pixel voltages in the transmissive area T1, and a curve 114 is a characteristic curve of the transmittance and the pixel voltages in the reflective area R1. Variation trends of the curve 112 and the curve 114 are quite different. When the transmissive area T1 and the reflective area R1 display an image of a same pixel voltage, luminance/gray levels of the displayed image are inconsistent, so that a display quality is poor.

Accordingly, designs of many kinds of the transflective LCD apparatus are focused on resolving such problem. FIG. 3 is a partial equivalent circuit diagram of another conventional single cell gap transflective LCD panel. Referring to FIG. 3, a pixel structure 226 in the single cell gap transflective LCD panel 220 is divided into a transmissive area T2 and a reflective area R2. Moreover, compared to the single cell gap transflective LCD panel 120 (shown in FIG. 1), the single cell gap transflective LCD panel 220 further provides a common voltage VcomB and an active device 226T electrically connected to the common voltage VcomB, wherein the common voltage VcomB has a constant voltage value. The pixel structure 226 further includes another compensation capacitor C_{CA} disposed in the reflective area R2, wherein one ends of the first liquid crystal capacitor C_{LCA} and the second liquid crystal capacitor C_{LCB} are electrically connected to the common voltage VcomA, and one end of the compensation capacitor C_{CA} is electrically connected to the common voltage VcomB through the active device 226T.

In the single cell gap transflective LCD panel 220, when the active device 226T is activated, the common voltage VcomB provides a divided voltage to the reflective area R2 through the compensation capacitor C_{CA}, so as to mitigate the problem of different luminance/gray levels of the image of the same pixel voltage displayed in the transmissive area T2 and the reflective area R2. However, when the active device 226T is deactivated, the compensation capacitor C_{CA} presents a floating state, which may lead to a horizontal crosstalk phenomenon of the displayed image.

### SUMMARY OF THE INVENTION

The present invention is directed to a liquid crystal display (LCD) apparatus, which can greatly mitigate a horizontal crosstalk phenomenon.

The present invention is directed to a driving method, which can be applied to an LCD apparatus to mitigate a horizontal crosstalk phenomenon.

The present invention provides an LCD apparatus including a display area and a reference voltage line, wherein the display area includes a plurality of scan lines, a plurality of data lines and a plurality of pixel structures. Each of the pixel structures is electrically connected to the corresponding scan/data line, and has a first pixel area and a second pixel area. The first pixel area includes a first liquid crystal capacitor, wherein one end of the first liquid crystal capacitor is electrically connected to a common voltage. The second pixel area includes a second liquid crystal capacitor and a first compensation capacitor, wherein one end of the second liquid crystal capacitor is electrically connected to the common voltage, one end of the first compensation capacitor is electrically connected to another end of the second liquid crystal capacitor, and another end of the first compensation capacitor is directly and electrically connected to a reference voltage source through the reference voltage line. The reference voltage source provides a reference voltage having a continuous periodic signal or a time-varying signal.

In an embodiment of the present invention, the reference voltage is a square-wave signal.

In an embodiment of the present invention, the scan lines respectively enable each row of the pixel structures by an enabling period, and a half-cycle of the reference voltage is equal to the enabling period.

In an embodiment of the present invention, during the enabling period, signal polarities of the reference voltage and data signal voltages on the data lines are the same relative to a polarity of the common voltage.

In an embodiment of the present invention, the reference voltage is synchronized to data signal voltages on the data lines, or a cycle of the reference voltage is the same to a cycle of the data signal voltage on the data line.

In an embodiment of the present invention, the reference voltage is synchronized to the data signal voltages on the data lines, and signal polarities of the reference voltage and the data signal voltages on the data lines are the same relative a polarity of the common voltage.

In an embodiment of the present invention, during the enabling period, a polarity of each of the data signal voltages on the data lines is the same relative to a polarity of the common voltage. In an embodiment, the data signal voltages on the data lines drive the pixel structures in an approach of polarity row inversion.

In an embodiment of the present invention, during the enabling period, pixel polarities of the driven row of the pixel structures are the same to a polarity of the reference voltage relative to the polarity of the common voltage.

In an embodiment of the present invention, each of the pixel structure includes an active device. A gate of the active device is electrically connected to the corresponding scan line, a source thereof is electrically connected to the corresponding data line, and a drain thereof is electrically connected to another end of the first liquid crystal capacitor, one end of a storage capacitor in the first pixel area, and one end of a second compensation capacitor in the second pixel area. In an embodiment, the first pixel area includes a transmissive area, and the second pixel area includes a first reflective area. Another end of the storage capacitor is electrically connected to the common voltage, and another end of the second compensation capacitor is electrically connected to another end of the second liquid crystal capacitor and the end of the first compensation capacitor. In an embodiment, the second pixel area further includes a second reflective area, wherein the second reflective area includes a third liquid crystal capacitor. One end of the third liquid crystal capacitor is electrically connected to the drain of the active device, and another end of the third liquid crystal capacitor is electrically connected to the common voltage. In an embodiment, the first reflective area and the second reflective area in each pixel structure respectively include a first reflective electrode and a second reflective electrode, and a ratio of area sizes of the first reflective electrode and the second reflective electrode is 5:1-10:1. In an embodiment, the ratio of the area sizes of the first reflective electrode and the second reflective electrode is 9:1.

The present invention provides a driving method for driving a display panel of an LCD apparatus. The display panel includes a plurality of scan lines, a plurality of data lines and a plurality of pixel structures, wherein the pixel structures are electrically connected to the corresponding scan lines and the corresponding data lines, and each of the pixel structure has a first pixel area and a second pixel area. The driving method includes following steps. First, each row of the pixel structures is enabled by an enabling period. Next, a plurality of data signal voltages is provided to the corresponding data lines. Next, a common voltage is provided to one end of a first liquid crystal capacitor of the first pixel area and one end of a second liquid crystal capacitor of the second pixel area. Next, a reference voltage is provided to one end of a first compensation capacitor of the second pixel area, wherein the reference voltage has a continuous periodic signal or a time-varying signal. Moreover, the reference voltage is synchronized to the data signal voltages, or a cycle of the reference voltage is equal to a cycle of the data signal voltage.

In an embodiment of the present invention, the driving method further includes providing a reference voltage source for generating the reference voltage, wherein the reference voltage source directly transmits the reference voltage to the first compensation capacitor through a reference voltage line without using any active device.

In an embodiment of the present invention, a half-cycle of the reference voltage is equal to the enabling period.

In an embodiment of the present invention, during the enabling period, signal polarities of the reference voltage and the data signal voltages are the same relative to a polarity of the common voltage.

In an embodiment of the present invention, during the enabling period, a polarity of the reference voltage relative to the polarity of the common voltage is the same to display polarities of the driven pixel structures.

In an embodiment of the present invention, during the enabling period, a polarity of each of the data signal voltages on the data lines is the same relative to a polarity of the common voltage.

In an embodiment of the present invention, the data signal voltages on the data lines drive the pixel structures in an approach of polarity row inversion.

In an embodiment of the present invention, the reference voltage is a square-wave signal.

By applying the driving method of the present invention to the LCD apparatus of the present invention, a poor display problem of the horizontal crosstalk phenomenon, etc. generated in the LCD apparatus can be greatly mitigated, so that the LCD apparatus of the present invention may have a high display quality.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a partial equivalent circuit diagram of a conventional single cell gap transflective LCD panel.

FIG. 2 is diagram illustrating characteristic curves of transmittance and pixel voltages of an image displayed in a transmissive area and a reflective area of FIG. 1.

FIG. 3 is a partial equivalent circuit diagram of another conventional single cell gap LCD panel.

FIG. 4 is a partial equivalent circuit diagram of a display panel in a transflective LCD apparatus according to an embodiment of the present invention.

FIG. 5 is a driving waveform diagram of a display panel according to an embodiment of the present invention.

FIG. 6 is a flowchart illustrating a driving method for driving a display panel of a transflective LCD apparatus according to an embodiment of the present invention.

FIG. 6A is a diagram illustrating characteristic curves of transmittance and pixel voltages of a transflective LCD apparatus according to a first embodiment of the present invention.

FIG. 7 is a partial equivalent circuit diagram of a display panel according to a second embodiment of the present invention.

FIG. 8 is a diagram illustrating characteristic curves of transmittance and pixel voltages of a transflective LCD apparatus according to a second embodiment of the present invention.

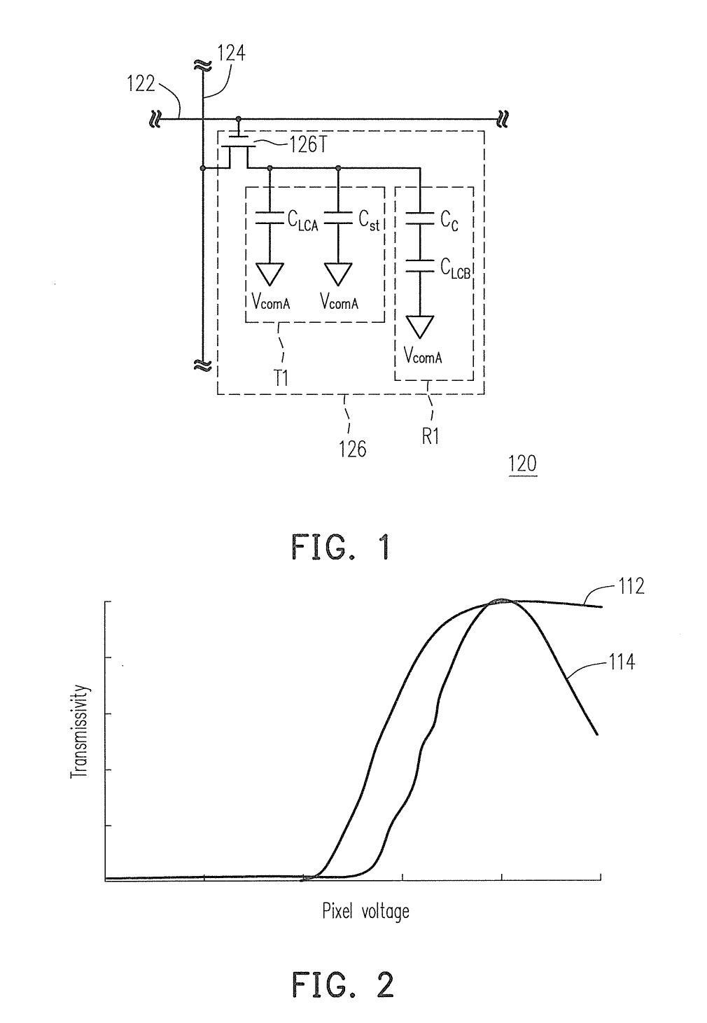

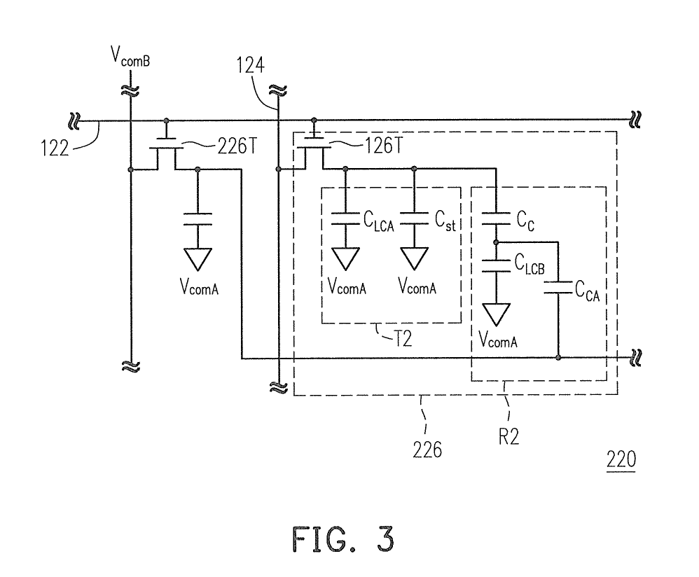

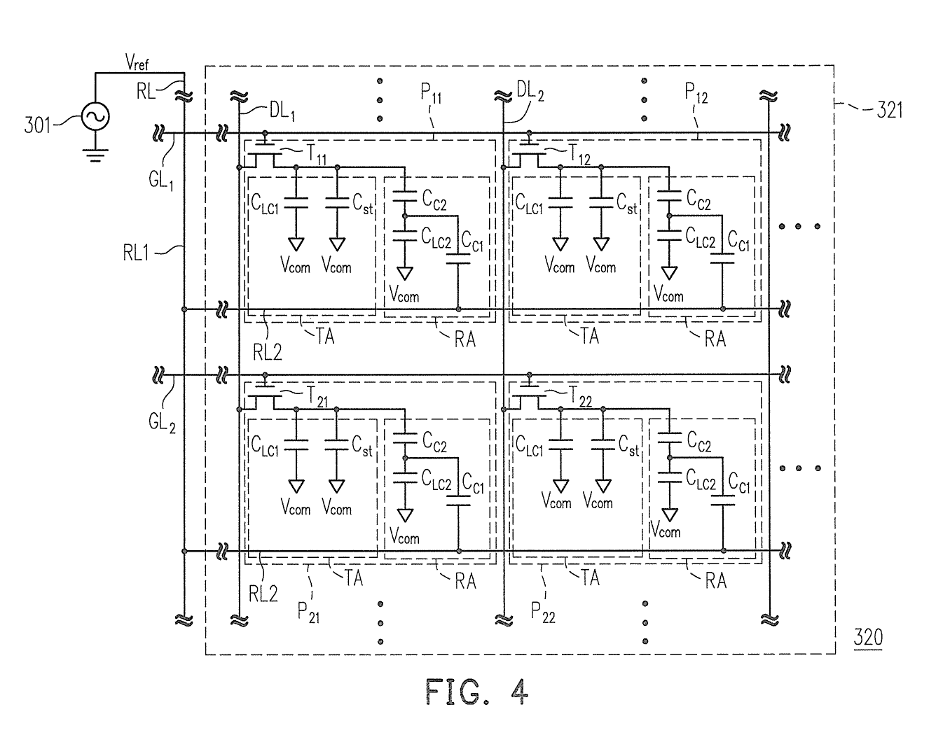

### DESCRIPTION OF THE EMBODIMENTS

### First Embodiment

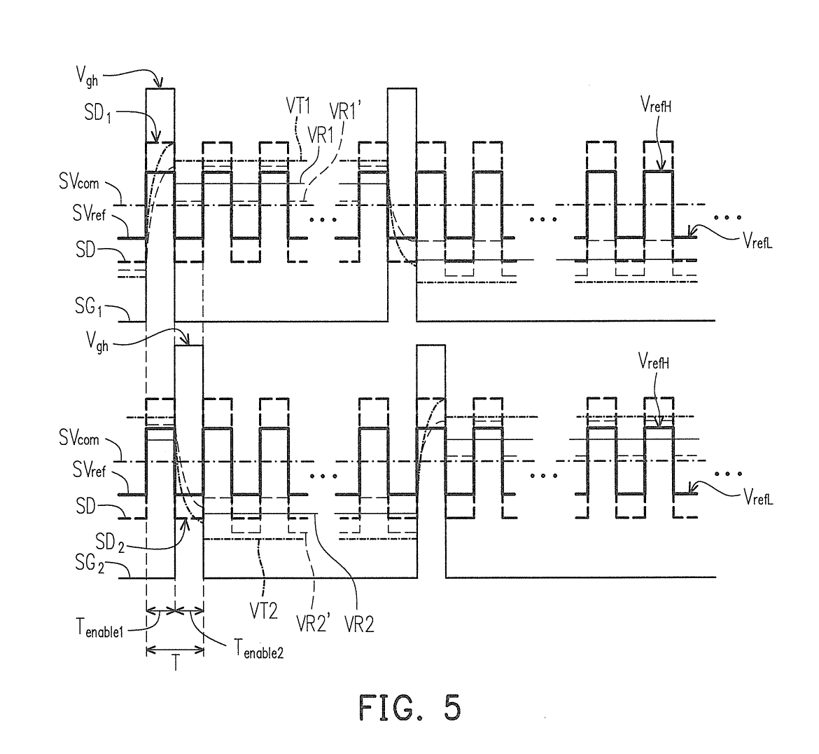

FIG. 4 is a partial equivalent circuit diagram of a display panel 320 in a transflective liquid crystal display (LCD) apparatus according to an embodiment of the present invention. It should be noticed that besides the display panel 320, the transflective LCD apparatus further includes other components of a general display apparatus, for example, a control panel, a gate driver, a source driver, a power generator, and a backlight module, etc., which are all not illustrated. For simplicity's sake, a coupling method between these components and the display panel 320, and descriptions of functions of the components are omitted, and only designs related to the present invention are illustrated and described.

Referring to FIG. 4, the display panel 320 of the present embodiment includes a plurality of scan lines GL₁, GL₂, . . . , a plurality of data lines DL₁, DL₂, . . . , and a plurality of pixel structures P₁₁, P₁₂, P₂₁, P₂₂, . . . to foam a plurality of pixel units. An area where the pixel units are formed is a display area 321 of the display panel 320, and an area outside the display area 321 is a non-display area of the display panel 320, wherein the pixel structures P₁₁, P₁₂, P₂₁, P₂₂, . . . are electrically connected to the corresponding scan lines GL₁, GL₂, . . . , and the corresponding data lines DL₁, DL₂, . . . . For example, the pixel structure P₁₁ is electrically connected to the scan line GL₁ and the data line DL₁, and coupling relations among the pixel structures P₁₂, P₂₁, P₂₂, . . . , the scan lines GL₁, GL₂, . . . , and the data lines DL₁, DL₂, . . . can be deduced by analogy, so that detail descriptions thereof are not repeated. Moreover, the display panel 320 further includes a reference voltage line RL for receiving a reference voltage Vref from a reference voltage source 301, wherein the reference voltage line RL is electrically connected to the pixel units.

In the present embodiment, the pixel structures P₁₁, P₁₂, P₂₁, P₂₂, . . . respectively include active device T₁₁, T₁₂, T₂₁, T₂₂, . . . , wherein a gate and a source of the active device T₁₁ are electrically connected to the scan line GL₁ and the data line DL₁, respectively. Moreover, coupling relations among the other active devices T₁₂, T₂₁, T₂₂, . . . , the corresponding scan lines GL₁, GL₂, . . . , and the corresponding data lines DL₁, DL₂, . . . can be deduced by analogy, and therefore detail descriptions thereof are not repeated.

Referring to FIG. 4 again, in the present embodiment, the display panel 320 is a single cell gap transflective LCD panel, so that each of the pixel structures P₁₁, P₁₂, P₂₁, P₂₂, . . . has a first pixel area and a second pixel area, wherein the first pixel area and the second pixel area of the present embodiment respectively contain a transmissive area TA and a reflective area RA.

It should be noticed that the so-called cell gap refers to a space thickness of a liquid crystal filling gap in a liquid crystal capacitor of the pixel structure, so that the so-call cell gap of the present embodiment refers to a distance between the pixel electrode of a first liquid crystal capacitor C_{LC1} in the transmissive area TA and the common electrode, or a distance between the reflective electrode of a second liquid crystal capacitor C_{LC2} in the reflective area RA and the common electrode, and the so-called single cell gap refers that a distance between the pixel electrode and the common electrode is approximate equal to a distance between the reflective electrode and the common electrode.

In the display panel 320, though the pixel structure having the transmissive area TA and the reflective area RA is taken as an example, the circuit structure and the related driving method of the present invention are not limited to such type of the display panel. In other words, in another embodiment, the display panel 320 can also be a non-transflective display panel.

Moreover, since the transflective LCD panel is not a self-luminous display panel, in an actual application, the transflective LCD apparatus 300 can further includes a backlight module for providing a light source required by the transmissive area TA, and the reflective area RA can use an external environmental light as a light source, which is not limited by the present invention.

Referring to FIG. 4 again, the transmissive areas TA and the reflective areas RA in the pixel structures P₁₁, P₁₂, P₂₁, P₂₂, . . . are electrically connected to the drains of the active devices T₁₁, T₁₂, T₂₁, T₂₂, . . . , respectively. Other circuit designs of the pixel structure can be deduced by analogy, and detailed descriptions thereof are omitted therein.

In detail, the transmissive area TA is electrically connected to a common voltage Vcom, and the reflective area RA is electrically connected to the reference voltage Vref provided by the reference voltage source 301 through the reference voltage line RL. In the present embodiment, the reference voltage line RL is not electrically connected to the reference voltage source 301 through a switch device (for example, an active device TFT, etc.) as that does of a conventional design, but is directly connected to the reference voltage source 301, so as to provide the reference voltage Vref to each of the pixel units. In other words, none switching device is configured on the reference voltage line RL between each of the pixel units and a reference voltage output point of the reference voltage source 301. It should be noticed that the reference voltage line RL can include a first reference voltage line RL1 disposed at the non-display area outside of the display area 321 of the display panel, and a plurality of second reference voltage lines RL2 distributed within the display area 321, though the present invention is not limited thereto. Wherein, each of the second reference voltage lines RL2 is directly connected to the first reference voltage line RL1 without using a switching device (for example, an active device). Moreover, the first reference voltage line RL1 and the second reference voltage line RL2 can be formed by a same conductive layer (for example, a metal layer), or can be formed by different conductive layers and are electrically connected via through holes or contact holes. Wherein, the first reference voltage line RL1 is approximately parallel to the data lines, and the second reference voltage lines RL2 are approximately parallel to the scan lines, though the present invention is not limited thereto. In an embodiment, the reference voltage source 301 can be provided by a control board or other signal generators of the display apparatus.

Generally, the display panel 320 can be formed by two substrates and a liquid crystal layer disposed there between, wherein a voltage difference between the two substrates can determine an arrangement state of liquid crystal molecules in the liquid crystal layer, so as to determine a light flux of the light passing through the liquid crystal layer, and the display panel 320 can accordingly display different gray levels. Namely, a size of the liquid crystal capacitors formed by the two substrates and the liquid crystal layer can determine the displayed gray levels of the display panel 320. In the present embodiment, the liquid crystal capacitor located in the transmissive area TA of the first pixel area is the first liquid crystal capacitor C_{LC1}, and two electrodes of the first liquid crystal capacitor C_{LC1} are formed by the pixel electrode and the common electrode. The liquid crystal capacitor located in the reflective area RA of the second pixel area is the second liquid crystal capacitor C_{LC2}, and two electrodes of the second liquid crystal capacitor C_{LC2} are formed by the reflective electrode and the common electrode. Referring to FIG. 4 again, one end of the first liquid crystal capacitor C_{LC1} is electrically connected to the drain of the active device T₁₁, and another end of the first liquid crystal capacitor C_{LC1} and one end of the second liquid crystal capacitor C_{LC2} are all electrically connected to the common voltage Vcom.

Moreover, in the pixel structures P₁₁, P₁₂, P₂₁, P₂₂, . . . , a storage capacitor Cₛₜ can be further disposed in each of the transmissive areas TA to improve the display quality, wherein two electrodes of the storage capacitors Cₛₜ are electrically connected to the drains of the active devices T₁₁, T₁₂, T₂₁, T₂₂, . . . and the common voltage Vcom, respectively.

Since the display panel 320 of the present embodiment has the single cell gap, i.e. the cell gap of the transmissive area TA is approximately equal to the cell gap of the reflective area RA, an optical path formed when the light provided by the backlight module enters the transmissive area TA is different to an optical path formed when the environmental light is reflected by the reflective area RA and emits from the display panel. Therefore, when the same pixel voltage is provided to the pixel electrode of the transmissive area TA and the reflective electrode of the reflective area RA, the same image displayed by the transmissive area TA and the reflective area RA may have the problem of inconsistent gray levels.

To resolve the above problem, a first compensation capacitor C_{C1} and a second compensation capacitor C_{C2} are further configured in each of the reflective areas RA. Moreover, circuit designs among the first and the second compensation capacitors C_{C1} and C_{C2} and other components, and a signal provided to the first compensation capacitor C_{C1} by the reference voltage Vref are also quite important.

As shown in FIG. 4, in the pixel structure P₁₁, one end of the second compensation capacitor C_{C2} is electrically connected to the drain of the active device T₁₁, and another end thereof is electrically connected to the second liquid crystal capacitor C_{LC2}. On the other hand, one end of the first compensation capacitor C_{C1} is electrically connected to the second compensation capacitor C_{C2} and the second liquid crystal capacitor C_{LC2}, and another end thereof is electrically connected to the reference voltage Vref. Coupling relations of the first compensation capacitors C_{C1} and the second compensation capacitors C_{C2} in the pixel structures P₁₂, P₂₁, P₂₂, . . . can be deduced by analogy.

Therefore, the first compensation capacitors C_{C1} can provides an additional divided voltage through the reference voltage Vref for generating a coupling voltage in the reflective area RA for the second liquid crystal capacitor C_{LC2}, so as to mitigate the problem of inconsistent gray levels of the same image displayed by the transmissive area TA and the reflective area RA, and accordingly match the characteristic curves of the transmittance and pixel voltages (which are also referred to as T-V curves) of an image displayed in the transmissive area TA and the reflective area RA.

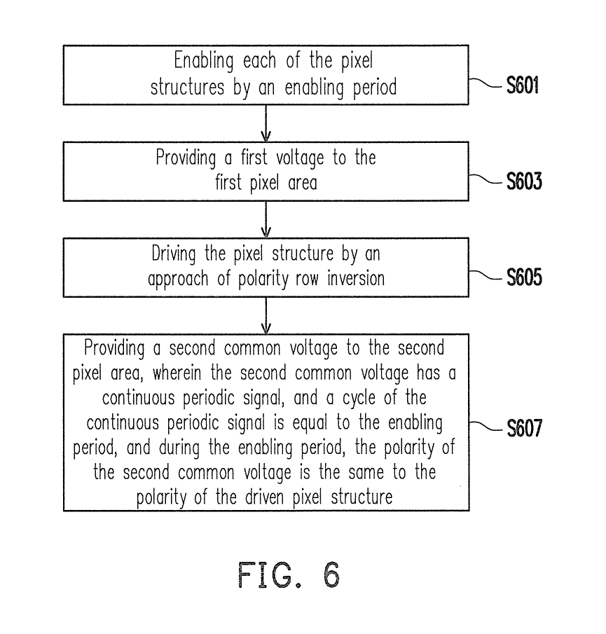

In the present embodiment, the reference voltage source 301 provides the reference voltage Vref having a time-varying signal or a continuous periodic signal to the reference voltage line RL as that shown in FIG. 5. FIG. 5 is a driving waveform diagram of a display panel according to an embodiment of the present invention, wherein SG₁, SG₂, SD, SVcom and SVref are, for example, respectively a waveform of the scan signal on the scan line GL₁, a waveform of the scan signal on the scan line GL₂, a waveform of the data signal on the data line DL₁, a signal waveform of the common voltage Vcom and a signal waveform of the reference voltage Vref on the reference voltage line RL. Moreover, VT1 and VR1 are respectively a signal waveform of the pixel electrode of the transmissive area TA and a signal waveform of the reflective electrode of the reflective area RA after the scan line GL₁ drives the pixel structure P₁₁ and writes a data signal therein. Similarly, VT2 and VR2 are respectively a signal waveform of the pixel electrode of the transmissive area TA and a signal waveform of the reflective electrode of the reflective area RA after the scan line GL₂ drives the pixel structure P₂₁ and writes a data signal therein.

Referring to FIG. 4 and FIG. 5, during an enabling period (activated period) T_{enable1} of the scan signal of the scan line GL₁, the waveform SG₁ of the scan signal of the scan line GL₁ provides a voltage level Vgh to enable (activate) the active devices T₁₁, T₁₂, T₁₃, . . . of one row of the pixel structures P₁₁, P₁₂, . . . in the display panel 320. Now, taking the pixel structure P₁₁ as an example, the pixel structure P₁₁ receives a data signal SD₁ from the data line DL₁, wherein signal polarities of the data signal SD₁ and the reference voltage Vref are the same relative to a polarity of the common voltage Vcom. For example, during the enabling period T_{enable1}, a voltage corresponding to the data signal SD₁ and the reference voltage Vref are all greater than the common voltage Vcom. Namely, the waveform of the data signal SD₁ and the signal waveform of the reference voltage Vref are all positive polarity relative to the signal waveform SVcom of the common voltage Vcom. Similarly, during the enabling period T_{enable1}, the signal polarities of the data signals of the other data lines DL₂, DL₃, . . . and the signal polarity of the reference voltage Vref are the same (for example, the positive polarity) relative to the polarity of the common voltage Vcom.

Therefore, based on the provided reference voltage Vref, after the enabling period (activated period) T_{enable1} is ended, and before the pixel structures P₁₁, P₁₂, . . . are enabled for a next time, image display polarities of the pixel structures Pᵤ, P₁₂, are the same (for example, the positive polarity). Moreover, based on the provided reference voltage Vref, electrode voltages of the liquid crystal capacitors in the transmissive area TA and the reflective area RA of each of the pixel structures can be suitably compensated. For example, as shown in FIG. 5, taking the pixel structure P₁₁ as an example, the voltage of the pixel electrode of the first liquid crystal capacitor C_{LC1} approximately has the signal waveform of VT1, and the voltage of the reflective electrode of the second liquid crystal capacitor C_{LC2} in the reflective area RA approximately has the signal waveform of VR1 due to a coupling effect of the first compensation capacitor C_{C1} and the second compensation capacitor C_{C2}.

During an enabling period (activated period) T_{enable2} of the scan signal of the next scan line GL₂, the waveform SG₂ of the scan signal of the scan line GL₂ provides the voltage level Vgh to enable the active devices T₂₁, T₂₂, T₂₃, . . . of a next row of the pixel structures P₂₁, P₂₂, . . . in the display panel 320. Now, taking the pixel structure P₂₁ as an example, the pixel structure P₂₁ receives a data signal SD₂ from the data line DL₁, wherein signal polarities of the data signal SD₂ and the reference voltage Vref are the same relative to the polarity of the common voltage Vcom. For example, during the enabling period T_{enable2}, the voltage corresponding to the data signal SD₂ and the reference voltage Vref are all less than the common voltage Vcom. Namely, the waveform of the data signal SD₂ and the signal waveform of the reference voltage Vref are all negative polarity relative to the signal waveform SVcom of the common voltage Vcom. Similarly, during the enabling period T_{enable2}, the signal polarities of the data signals of the other data lines DL₂, DL₃, . . . and the signal polarity of the reference voltage Vref are the same (for example, the negative polarity) relative to the polarity of the common voltage Vcom.

Therefore, after the enabling period T_{enable2} is ended, and before the pixel structures P₁₁, P₁₂, . . . are enabled for a next time, image display polarities of the pixel structures P₁₁, P₁₂, . . . are the same (for example, the negative polarity). Moreover, based on the provided reference voltage Vref, electrode voltages of the liquid crystal capacitors in the transmissive area TA and the reflective area RA of each of the pixel structures can be suitably compensated. For example, as shown in FIG. 5, taking the pixel structure P₂₁ as an example, the voltage of the pixel electrode of the first liquid crystal capacitor C_{LC1} approximately has the signal waveform of VT2, and the voltage of the reflective electrode of the second liquid crystal capacitor C_{LC2} in the reflective area RA approximately has the signal waveform of VR2 due to a coupling effect of the first compensation capacitor C_{C1} and the second compensation capacitor C_{C2}.

In the present embodiment, a voltage value corresponding to the signal waveform SVcom of the common voltage Vcom is, for example, a constant voltage value (i.e. is a non-time-varying signal). Regarding the data signal of each of the data lines DL₁, DL₂, . . . , the polarities of two adjacent continuous waveforms are inversed relative to the polarity of the signal waveform of the common voltage Vcom. For example, taking the date signal SD of FIG. 5 as an example, during the two enabling periods (for example, T_{enable1} and T_{enable2}), the adjacent data signal waveforms are respectively SD₁ and SD₂, and the polarities of the data signal waveforms SD₁ and SD₂ are inversed relative to the polarity of the common voltage Vcom. Namely, the data lines DL₁, DL₂, . . . drive the display panel in an approach of polarity row inversion. One the other hand, the signal waveform SVref of the reference voltage Vref is a continuous periodic signal or a time-varying signal, for example, a square-wave signal having a continuous periodic signal or other periodic waveform signals. Wherein, a cycle of the signal waveform SVref of the reference voltage Vref is the same to a cycle of the data signal SD, i.e. the reference voltage Vref is synchronized to the data signal, or a half-cycle (T/2) of the reference voltage Vref is equal to one of the enabling periods (activated period) T_{eanble1}, T_{enable2}, . . . etc.

Moreover, during any of the enabling periods, the polarities of the signal waveform SVref of the reference voltage Vref and the signal waveform of the data signal on the data line DL₁, DL₂, . . . are the same relative to the polarity of the signal waveform of the common voltage Vcom. For example, during the enabling period T_{eanble1}, the polarity of the data signal waveform SD₁ on the data line DL₁, DL₂, . . . is positive relative to the polarity of the common voltage Vcom, and the polarity of the reference voltage Vref is also positive relative to the polarity of the common voltage Vcom, so that the display polarities of the driven pixel structures P₁₁, P₁₂, . . . are all positive. Namely, the signal waveforms VT1 and VR1 of the pixel electrode and the reflective electrode in the transmissive area TA and the reflective area RA of each of the pixel structures P₁₁, P₁₂, . . . all have the positive polarity relative to the polarity of the common voltage Vcom.

Deduced by analogy, during the enabling period T_{enable2} of the next scan line GL₂, the polarities of the voltage corresponding to the data signal waveform SD₂ of the data line DL₁, DL₂, . . . and the reference voltage Vref and are all negative relative to the polarity of the common voltage Vcom, so that the display polarities of the driven pixel structures P₂₁, P₂₂, . . . are all negative. Namely, the signal waveforms VT2 and VR2 of the pixel electrode and the reflective electrode in the transmissive area TA and the reflective area RA of each of the pixel structures P₂₁, P₂₂, . . . all have the negative polarity relative to the polarity of the common voltage Vcom.

It should be noticed that for simplicity's sake, the signal waveforms of the reflective electrode of the reflective area RA during the enabling periods T_{eanble1} and T_{eanble2} are respectively represented by VR1 and VR2 shown in FIG. 5. However, those skilled in the art should understand that since the signal waveform VR1 is generated according to the voltage of the reflective electrode of the second liquid crystal capacitor C_{LC2} in the reflective area RA through the coupling effect of the first compensation capacitor C_{C1} and the second compensation capacitor C_{C2}, during the enabling period T_{eanble1}, the signal waveform of the reflective electrode in the reflective area RA is certainly influenced by the signal waveform SVref of the reference voltage Vref to present an uneven ripple appearance, i.e. an actual signal waveform is VR1′ as that shown in FIG. 5. Deduced by analogy, an actual signal waveform of the reflective electrode in the reflective area RA during the enabling period T_{enable2} is VR2′ as that shown in FIG. 5.

In the present embodiment, the signal waveforms VR1 and VR2 are obtained by respectively calculating root mean square (RMS) values of the ripples of the signal waveforms VR1′ and VR2′. Since the ripples of the signal waveforms VR1′ and VR2′ are generated according to the signal waveform SVref of the reference voltage Vref, the signal waveforms VR1 and VR2 can be obtained by calculating the RMS values of the signal waveform SVref of the reference voltage Vref. Assuming a peak value and a trough value of the signal waveform SVref are respectively V_{refH} and V_{refL} (as that shown in FIG. 5), the RMS value of the signal waveform SVref is:

$${V}_{ref , RMS} = \sqrt{\frac{{V}_{refH}^{2} + {V}_{refL}^{2}}{2}} .$$

Therefore, a relation between the signal waveform VT1 of the tranmissive area TA and the signal waveform VR1 of the reflective area RA is:

$$\begin{matrix}VR 1 = \frac{{C}_{C 2}}{{C}_{C 1} + {C}_{C 2} + {C}_{LC 2}} \times VT 1 + \frac{{C}_{C 1}}{{C}_{C 1} + {C}_{C 2} + {C}_{LC 2}} \times Δ {V}_{COM} \\ = \frac{{C}_{C 2}}{{C}_{C 1} + {C}_{C 2} + {C}_{LC 2}} \times VT 1 + \frac{{C}_{C 1}}{{C}_{C 1} + {C}_{C 2} + {C}_{LC 2}} \times \vert \begin{matrix}{V}_{ref , RMS} - \\ {V}_{COM}\end{matrix} \vert \\ = \frac{{C}_{C 2}}{{C}_{C 1} + {C}_{C 2} + {C}_{LC 2}} \times VT 1 + \frac{{C}_{C 1}}{{C}_{C 1} + \begin{matrix}{C}_{C 2} + \\ {C}_{LC 2}\end{matrix}} \times \vert \sqrt{\frac{\begin{matrix}{V}_{refH}^{2} + \\ {V}_{refL}^{2}\end{matrix}}{2}} - {V}_{COM} \vert\end{matrix}$$

Similarly, the signal waveform VR2 can be deduced according to the same approach.

According to the descriptions of the related art, it is known that one end of the first compensation capacitor C_{C1} in the reflective area RA is electrically connected to an additional active device, and the active device is actively controlled to receive a non-time-varying common voltage Vcom2, and when the additional active device is deactivated, the first compensation capacitor C_{C1} presents a floating state, which may lead to a horizontal crosstalk phenomenon of the displayed image. However, in the present embodiment, the first compensation capacitor C_{C1} in the reflective area RA is directly connected to a voltage source without using the active device, and the first compensation capacitor C_{C1} is electrically connected to the reference voltage Vref having a continuous periodic signal, wherein there is a special corresponding relation between the reference voltage Vref and the cycle and the polarity of the data signal. Therefore, generation of the floating state of the first compensation capacitor C_{C1} is avoided, so that the horizontal crosstalk phenomenon can be mitigated.

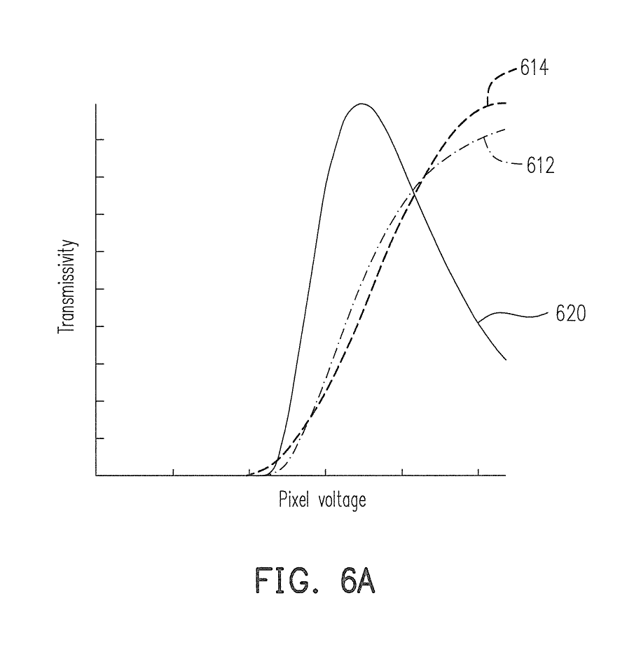

According to the above descriptions, the present invention further provides a driving method as that shown in FIG. 6, wherein the driving method is suitable for driving the display panel 320 of the transflective LCD apparatus, though the present invention is not limited thereto, and the components of the display panel 320 and the coupling relations thereof are the same as that described in the embodiment of FIG. 4.

Referring to FIG. 4 and FIG. 6, in step S601, an enabling signal is sequentially written to each of the scan lines to enable each row of the pixel structures, so as to activate the active devices T₁₁, T₁₂, . . . in each row of the pixel structures. In the present embodiment, the pixel structures P₁₁, P₁₂, . . . are, for example, a first row of the pixel strictures in the display panel, and the pixel structures P₂₁, P₂₂, . . . are, for example, a second row of the pixel structures in the display panel. In step S603, the common voltage Vcom is provided to a first and a second pixel areas of each of the pixel structures, wherein the first pixel area of the present embodiment includes a transmissive area TA1, and the second pixel area includes a reflective area RA1. In step S605, a data signal is written to each of the data lines DL₁, DL₂, . . . . Preferably, polarities of the data signals on the data lines are the same relative to the polarity of the common voltage Vcom during a same enabling period (activated period), and regarding the data signal of each of the data lines, polarities of two adjacent continuous waveforms are inversed relative to the polarity of the signal waveform of the common voltage Vcom. In step S607, the reference voltage Vref is provided to the first compensation capacitor C_{C1} in the second pixel area of the pixel structure, wherein the reference voltage Vref is a time-varying signal or a continuous periodic signal. Preferably, a half-cycle of a signal of the reference voltage Vref is equal to the enabling period or a cycle of the reference voltage Vref is equal to a cycle of the data signal, i.e. the signal of the reference voltage Vref is synchronized to the data signal. Moreover, during each of the enabling periods, polarities of the reference voltage Vref and the corresponding data signal voltage are the same relative to the polarity of the common voltage. However, the steps S601, S603, S605 and S607 are not used for limiting a sequence of the steps of the driving method of the present embodiment, and the sequence can be varied or the steps can be combined according to a demand of a designer, wherein the sequence of the steps and other details of the driving method are included in the aforementioned embodiment, and thereof detailed descriptions thereof are not repeated.

Based on the display panel 320 and the driving method thereof, FIG. 6A is a diagram illustrating characteristic curves of transmittance and pixel voltages of a transflective LCD apparatus according to the first embodiment of the present invention. Referring to FIG. 4 and FIG. 6, a curve 612 represents a characteristic curve of the transmittance and the pixel voltages in the transmissive area TA, a curve 614 represents a characteristic curve of the transmittance and the pixel voltages in the reflective area RA, and a curve 620 represents a characteristic curve of the transmittance and the pixel voltages in the conventional reflective area. According to FIG. 6A, it is known that the curves 612 and 614 are similar, though a variation trend of the curve 612 is quite different to that of the curve 620. In other words, by using the transflective LCD apparatus 300 of the present embodiment, a mismatch problem between the characteristic curves of the transmittance and the pixel voltages of the transmissive area and the reflective area in the conventional transflective LCD apparatus can be greatly mitigated.

### Second Embodiment

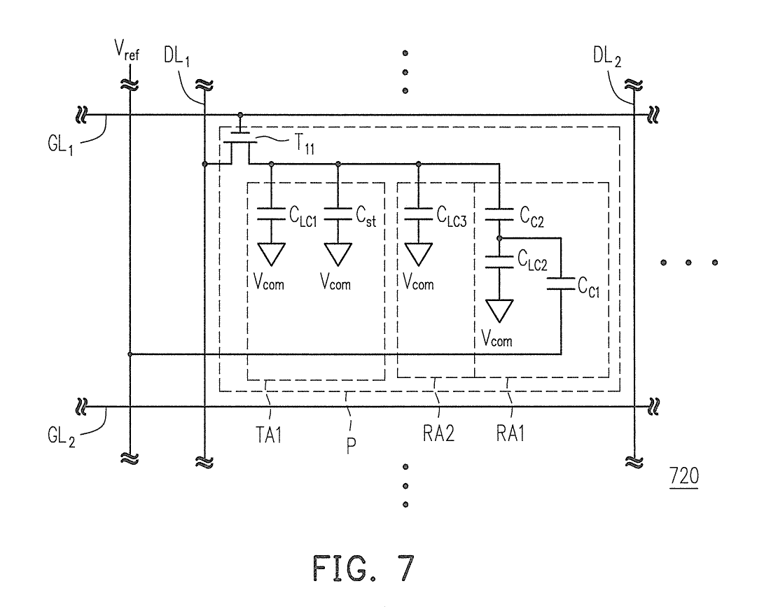

The spirit of the present embodiment is similar to that of the first embodiment. However, in the present embodiment, the second pixel area of each of the pixel structures further includes another reflective area RA2 as that shown in FIG. 7, wherein only one pixel unit is illustrated in FIG. 7. Moreover, like reference numerals in the present embodiment and the first embodiment refer to the same or like elements, and therefore detailed descriptions thereof are not repeated.

FIG. 7 is a partial equivalent circuit diagram of a display panel according to the second embodiment of the present invention. Referring to FIG. 7, each of pixel structures P in the display panel 720 of the present embodiment has a first pixel area and a second pixel area, wherein the first pixel area includes a transmissive area TA1, and the second pixel area includes a first reflective area RA1 and a second reflective area RA2.

In the present embodiment, a liquid crystal capacitor in the transmissive area TA1 is a first liquid crystal capacitor C_{LC1}, a liquid crystal capacitor in the first reflective area RA1 is a second liquid crystal capacitor C_{LC2}, and a liquid crystal capacitor in the second reflective area RA2 is a third liquid crystal capacitor C_{LC3}. One ends of the first, the second and the third liquid crystal capacitors C_{LC1}, C_{LC2} and C_{LC3} are directly or indirectly (through a capacitor) connected to the drain of the active device T₁₁, respectively, and other ends thereof are electrically connected to the common voltage Vcom. Moreover, the first, the second and the third liquid crystal capacitors C_{LC1}, C_{LC2} and C_{LC3} respectively include a pixel electrode, a first reflective electrode and a second reflective electrode, and these electrodes are mutually independent and separated. In addition, the storage capacitor Cₛₜ can be further configured in the transmissive area TA1 of the first pixel area for improving the display quality, wherein two ends of the storage capacitor Cₛₜ are electrically connected to the drain of the active device T₁₁ and the common voltage Vcom, respectively.

Coupling relations of the components in the transmissive area TA1 of the first pixel area and the first reflective area RA1 of the second pixel area are similar to that in the transmissive area TA and the reflective area RA of the first embodiment, so that a driving method for the transmissive area TA1 and the first reflective area RA1 of each of the pixel structures P in the display panel 720 is the same as that described in the first embodiment with reference of FIG. 5 and FIG. 6, and therefore detail descriptions thereof are not repeated.

As described above, in the second pixel area of the present embodiment, one end of the third liquid crystal capacitor C_{LC3} in the second reflective area RA2 is electrically connected to the second compensation capacitor C_{C2} and the drain of the active device T₁₁, and another end thereof is electrically connected to the common voltage Vcom. According to another aspect, one ends of the first and the third liquid crystal capacitors C_{LC1} and C_{LC3} are electrically connected to the drain of the active device T₁₁, and the other ends of the first and the third liquid crystal capacitors C_{LC1} and C_{LC3} are electrically connected to the common voltage Vcom. In an actual application, the first liquid crystal capacitor C_{LC1} in the transmissive area TA1 can be formed by a transparent pixel electrode, a counter electrode having the common voltage Vcom, and a liquid crystal layer disposed there between. The third liquid crystal capacitor C_{LC3} in the second reflective area RA2 can be formed by a reflective pixel electrode, a counter electrode having the common voltage Vcom, and a liquid crystal layer disposed there between, wherein the transparent pixel electrode and the reflective electrode are mutually independent and separated.

Moreover, in the present embodiment, a driving method corresponding to the circuit designs of the transmissive area TA1 and the first and the second reflective areas RA1 and RA2 is similar as the driving method described in the first embodiment with reference of FIG. 6. Namely, though the second reflective area RA2 is added to the present embodiment, the driving method of the display panel 720 is still similar to that of the first embodiment. In detail, in the step S601, an enabling signal is sequentially written to each of the scan lines to enable each row of the pixel structures, so as to activate the active devices T₁₁, T₁₂, . . . in each row of the pixel structures. In the present embodiment, the pixel structures P₁₁, P₁₂, . . . are, for example, a first row of the pixel strictures in the display panel, and the pixel structures P₂₁, P₂₂, . . . are, for example, a second row of the pixel structures in the display panel. In the step S603, the common voltage Vcom is provided to a first and a second pixel areas of each of the pixel structures, wherein the first pixel area of the present embodiment includes a transmissive area TA1, and the second pixel area includes a first reflective area RA1 and a second reflective area RA2. In the step S605, a data signal is written to each of the data lines DL₁, DL₂, . . . . Preferably, polarities of the data signals on the data lines are the same relative to the polarity of the common voltage Vcom during a same enabling period (activated period), and regarding the data signal of each of the data lines, polarities of two adjacent continuous waveforms are inversed relative to the polarity of the signal waveform of the common voltage Vcom. In the step S607, the reference voltage Vref is provided to one end of the first compensation capacitor C_{C1} in the second pixel area, wherein the reference voltage Vref is a time-varying signal or a continuous periodic signal. Preferably, a half-cycle of a signal of the reference voltage Vref is equal to the enabling period or a cycle of the reference voltage Vref is equal to a cycle of the data signal on the data line, i.e. the signal of the reference voltage Vref is synchronized to the data signal. Moreover, during each of the enabling periods, polarities of the reference voltage Vref and the data signal are the same relative to the polarity of the common voltage. However, the steps S601, S603, S605 and S607 are not used for limiting a sequence of the steps of the driving method, wherein the sequence of the steps and other details of the driving method are already included in the first embodiment, and thereof detailed descriptions thereof are not repeated.

It should be noticed that in the present embodiment, the pixel structure is formed by one transmissive area TA1 and two reflective areas RA1 and RA2, so that the poor display problem such as the horizontal crosstalk phenomenon, etc. can further be effectively mitigated. The first reflective electrode in the first reflective area RA1 and the second reflective electrode in the second reflective area RA2 are mutually independent and separated. Regarding area sizes of the two reflective areas, the area size of the first reflective area RA1 is basically greater than that of the second reflective area RA2, for example, a ratio of the two area sizes can be 5:1-10:1. In an exemplary embodiment, if a ratio of the area sizes of the first reflective electrode in the first reflective area RA1 and the second reflective electrode in the second reflective area RA2 is 9:1, the characteristic curves of the transmittance and the pixel voltages of an image displayed in the transmissive area TA1 and the reflective areas RA1 and RA2 can be preferably matched.

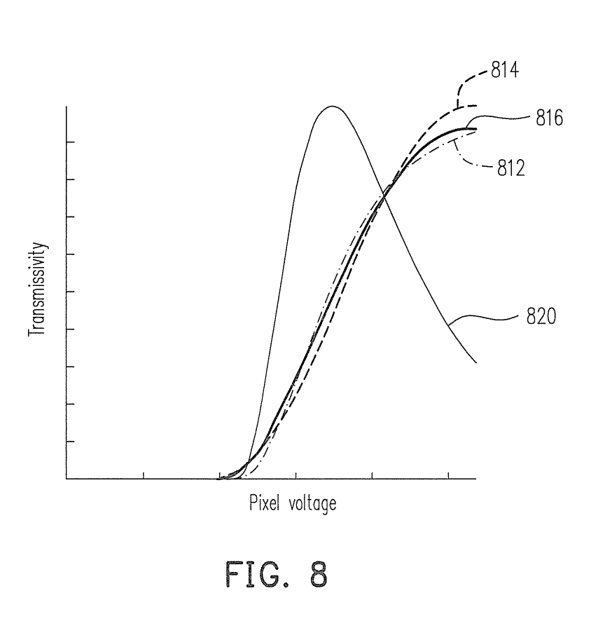

Based on the display panel 720 and the driving method thereof, FIG. 8 is a diagram illustrating characteristic curves of transmittance and pixel voltages of a transflective LCD apparatus according to the second embodiment of the present invention. Referring to FIG. 4, FIG. 7 and FIG. 8, a curve 812 represents a characteristic curve of the transmittance and the pixel voltages of the transmissive area TA1 in a pixel unit of the present embodiment and the first embodiment, a curve 814 represents a characteristic curve of the transmittance and the pixel voltages in the reflective area RA of the first embodiment, a curve 816 represents a characteristic curve of the transmittance and the pixel voltages in the first reflective area RA1 and the second reflective area RA2 of the present embodiment, and a curve 820 represents a characteristic curve of the transmittance and the pixel voltages in the conventional reflective area.

According to FIG. 8, it is known that a variation trend of the curve 812 is quite different to that of the curve 820, though the curves 812, 814 and 816 are similar, wherein the curve 816 is closer to the curve 812 compared to the curve 814. Therefore, by using the transflective LCD apparatus 720 of the present embodiment, not only the mismatch problem between the characteristic curves of the transmittance and the pixel voltages of the transmissive area and the reflective area in the conventional transflective LCD apparatus can be greatly mitigated, but also the display quality of the display panel 720 can be further improved compared to that of the display panel 320.

In summary, each of the pixel structures in the display panel of the transflective LCD apparatus of the present invention can be divided into a first pixel area and a second pixel area, wherein the first pixel area includes a transmissive area, and a first liquid crystal capacitor therein is electrically connected to a common voltage, and the second pixel area includes at least one reflective area, and a second liquid crystal capacitor therein is electrically connected to a reference voltage having a time-varying signal or a continuous periodic signal. By applying the driving method of the present invention to the transflective LCD apparatus, the poor image display problem such as the horizontal crosstalk phenomenon of the LCD apparatus can be greatly mitigated. Therefore, the LCD apparatus of the present invention has an advantage of high display quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid crystal display (LCD) apparatus, comprising:
a reference voltage line, and
a display area, comprising a plurality of scan lines, a plurality of data lines and a plurality of pixel structures electrically connected to the scan lines and the data lines, each of the pixel structures comprising:
a first pixel area, comprising a first liquid crystal capacitor, and one end of the first liquid crystal capacitor being electrically connected to a common voltage; and
a second pixel area, comprising a second liquid crystal capacitor and a first compensation capacitor, wherein one end of the second liquid crystal capacitor is electrically connected to the common voltage, one end of the first compensation capacitor is electrically connected to another end of the second liquid crystal capacitor, and another end of the first compensation capacitor is directly and electrically connected to a reference voltage source through the reference voltage line, and the reference voltage source provides a reference voltage having a continuous periodic signal or a time-varying signal.

2. The LCD apparatus as claimed in claim 1, wherein the reference voltage is a square-wave signal.

3. The LCD apparatus as claimed in claim 1, wherein the scan lines respectively enable each row of the pixel structures by an enabling period, and a half-cycle of the reference voltage is equal to the enabling period.

4. The LCD apparatus as claimed in claim 1, wherein during the enabling period, signal polarities of the reference voltage and data signal voltages on the data lines are the same relative to a polarity of the common voltage.

5. The LCD apparatus as claimed in claim 1, wherein the reference voltage is synchronized to data signal voltages on the data lines, or a cycle of the reference voltage is the same to a cycle of the data signal voltage on the data line.

6. The LCD apparatus as claimed in claim 1, wherein the reference voltage is synchronized to the data signal voltages on the data lines, and signal polarities of the reference voltage and the data signal voltages on the data lines are the same relative a polarity of the common voltage.

7. The LCD apparatus as claimed in claim 1, wherein the reference voltage line comprises a first reference voltage line and a plurality of second reference voltage lines, the first reference voltage line is disposed in a non-display area outside the display area, and the second reference voltage lines are distributed in the display area.

8. The LCD apparatus as claimed in claim 7, wherein the second reference voltage lines are parallel to the scan lines.

9. The LCD apparatus as claimed in claim 7, wherein the first reference voltage line and the second reference voltage lines are respectively formed by different conductive layers, and are electrically connected through a contact hole.

10. The LCD apparatus as claimed in claim 3, wherein during the enabling period, a polarity of each of the data signal voltages on the data lines is the same relative to a polarity of the common voltage.

11. The LCD apparatus as claimed in claim 10, wherein the data signal voltages on the data lines drive the pixel structures in an approach of polarity row inversion.

12. The LCD apparatus as claimed in claim 1, wherein during the enabling period, pixel polarities of the driven row of the pixel structures are the same to a polarity of the reference voltage relative to the polarity of the common voltage.

13. The LCD apparatus as claimed in claim 1, wherein each of the pixel structures comprises:
an active device, having a gate electrically connected to the corresponding scan line, a source electrically connected to the corresponding data line, and a drain electrically connected to another end of the first liquid crystal capacitor, one end of a storage capacitor in the first pixel area, and one end of a second compensation capacitor in the second pixel area.

14. The LCD apparatus as claimed in claim 13, wherein the first pixel area comprises a transmissive area, and the second pixel area comprises a first reflective area, another end of the storage capacitor is electrically connected to the common voltage, and another end of the second compensation capacitor is electrically connected to another end of the second liquid crystal capacitor and the end of the first compensation capacitor.

15. The LCD apparatus as claimed in claim 14, wherein the second pixel area further comprises a second reflective area, wherein the second reflective area comprises a third liquid crystal capacitor, one end of the third liquid crystal capacitor is electrically connected to the drain of the active device, and another end of the third liquid crystal capacitor is electrically connected to the common voltage.

16. The LCD apparatus as claimed in claim 15, wherein the first reflective area and the second reflective area respectively comprise a first reflective electrode and a second reflective electrode, and a ratio of area sizes of the first reflective electrode and the second reflective electrode is 5:1-10:1.

17. The LCD apparatus as claimed in claim 16, wherein the ratio of the area sizes of the first reflective electrode and the second reflective electrode is 9:1.

18. A driving method, for driving a display panel of an LCD apparatus, the display panel comprising a plurality of scan lines, a plurality of data lines and a plurality of pixel structures electrically connected to the scan lines and the data lines, and each of the pixel structure comprising a first pixel area and a second pixel area, and the driving method comprising:
enabling each row of the pixel structures by an enabling period;
providing a plurality of data signal voltages to the data lines;
providing a common voltage to one end of a first liquid crystal capacitor of each of the first pixel areas and one end of a second liquid crystal capacitor of each of the second pixel areas; and
providing a reference voltage to one end of a first compensation capacitor of each of the second pixel areas, wherein the reference voltage has a continuous periodic signal or a time-varying signal,
and the reference voltage is synchronized to the data signal voltages, or a cycle of the reference voltage is equal to a cycle of the data signal voltage.

19. The driving method as claimed in claim 18, further comprising providing a reference voltage source for generating the reference voltage, wherein the reference voltage source directly transmits the reference voltage to the first compensation capacitor through a reference voltage line without using any active device.

20. The driving method as claimed in claim 18, wherein a half-cycle of the reference voltage is equal to the enabling period.

21. The driving method as claimed in claim 18, wherein during the enabling period, signal polarities of the reference voltage and the data signal voltages are the same relative to a polarity of the common voltage.

22. The driving method as claimed in claim 18, wherein during the enabling period, a polarity of the reference voltage relative to the polarity of the common voltage is the same to display polarities of the driven pixel structures.

23. The driving method as claimed in claim 18, wherein during the enabling period, a polarity of each of the data signal voltages on the data lines is the same relative to a polarity of the common voltage.

24. The driving method as claimed in claim 23, wherein the data signal voltages on the data lines drive the pixel structures in an approach of polarity row inversion.

25. The driving method as claimed in claim 18, wherein the reference voltage is a square-wave signal.

26. The driving method as claimed in claim 18, wherein the first pixel area comprises a transmissive area, and the second pixel area comprises a first reflective area.

27. The driving method as claimed in claim 26, wherein the second pixel area further comprises a second reflective area, wherein the second reflective area comprises a third liquid crystal capacitor, and one end of the third liquid crystal capacitor is connected to the common voltage.

28. The driving method as claimed in claim 27, wherein the first reflective area and the second reflective area in each of the pixel structures respectively comprise a first reflective electrode and a second reflective electrode, and a ratio of area sizes of the first reflective electrode and the second reflective electrode is 5:1-10:1.
